(19) United States
(12) Patent Application Publication
(10) Pub. No.: US 2010/0002635 A1
(43) Pub. Date: Jan. 7, 2010

(54) NAME SERVICE IN A MULTIHOP WIRELESS AD HOC NETWORK

(75) Inventor: Carl Eklund, Helsinki (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: NOKIA CORPORATION, Espoo (FI)

(21) Appl. No.: 11/795,082

(22) PCT Filed: Jan. 12, 2005
(86) PCT No.: PCT/FI2005/000015

§ 371 Date: Sep. 17, 2009

(51) Int. Cl. H04W 72/04

(52) U.S. Cl. 370/329

(57) ABSTRACT

Piggy-backed requests for resources are handled in a packet-switched communications system. A terminal arrangement sends an access request to a network element in order to request permission to use communications resources for transmitting a data packet found in a transmission buffer of the terminal arrangement. Knowledge is established about a predicted data packet which is to appear in the transmission buffer of the terminal arrangement in the near future. The terminal arrangement transmits to the network element an access request for predicted traffic, requesting permission to use communications resources for transmitting said predicted data packet once it appears. This access request for predicted traffic is piggy-backed onto another transmission.

### TECHNICAL FIELD

The invention concerns the technical field of media access control in communication connections where a transmitting device must request a resource allocation before it can transmit a piece of information. Especially the invention is related to optimizing the signaling aspect, i.e. finding an advantageous way for arranging the transmission and reception of control messages that are needed for securing a resource allocation.

### BACKGROUND OF THE INVENTION

A basic principle of packet-switched communications between multiple users is that transmission bandwidth is only reserved when there is something to be transmitted. Resources such as frequency and time are scarce, and a transmitting terminal arrangement must request a resource allocation before it can transmit a piece of information. A network element, which in cellular radio networks is typically an RNC (Radio Network Controller), grants resource allocations to those who have made their requests. The request for resources (also commonly referred to as the access request) and the grant message represent signaling or control messages that are needed for operating the communications system but do not carry payload information.

In radio systems utilizing multicarrier techniques, such as OFDM (Orthogonal Frequency Division Modulation), symbol size becomes relatively large. If the number of subcarriers is in the order of thousands, transmitting short control messages will involve a large overhead: the information capacity of even the simplest control message having a minimum number of symbols is easily far larger than is actually needed for conveying the contents of the control message. Additional overhead comes from the preambles, training sequences, phase references and other corresponding parts of transmissions that need to be there for enabling successful reception but that do not carry any meaningful information.

In order to avoid transmission overheads the principle of so-called piggy-backing has been proposed, meaning that the contents of a control message are multiplexed to some other transmission whenever possible. A general definition of the concept “piggy-backing” a first transmission onto a second transmission could be “combining a (small) first transmission with a (larger) second transmission, resulting in a common combined transmission that conveys the essential information content that would otherwise be transmitted separately in a first transmission and a second transmission”.

FIG. 1 illustrates a known principle of piggy-backing access requests. At the first stage there are two packets of data in the transmit buffer of a terminal arrangement, which causes said terminal arrangement to transmit an access request 101 where it asks the network terminal that is responsible of resource allocations to grant the resources needed to transmit two packets of data. In the drawing the short parallel line in the middle of the arrow indicates a control message. Said network element makes an allocation decision and transmits a grant message 102 to the terminal arrangement. At the first allocated transmission instant the terminal arrangement transmits the first packet, as is shown at stage 103. Before the second allocated transmission instant occurs, however, a third packet appears in the transmission buffer. Therefore at stage 104 the terminal arrangement transmits not only the second packet but also a piggy-backed access request for the additional resources it needs for transmitting the third packet. At stage 105 the network element responds with a grant message indicating a resource allocation for the third packet, which is subsequently transmitted at stage 106.

At the moment of transmitting the third packet the transmission buffer of the terminal arrangement is empty, so the terminal arrangement does not transmit any additional access requests. Later, when a fourth packet appears in the transmission buffer, the terminal arrangement must transmit a further access request at step 107, followed by a grant message 108 and the transmission of said fourth packet at step 109.

The disadvantages of the prior art method become most apparent in situations where an application at the terminal arrangement only produces uplink data packets at intervals that are longer than the so-called round trip time of the medium access protocol, which can be defined as the time from the moment when the terminal arrangement transmitted an access request to the moment at which it makes a subsequent transmission utilizing the resources that were granted in response to said access request. If the application produced packets at a higher rate, at least one new packet would always make it to the transmission buffer before the previous ones were transmitted, and new access requests could be piggy-backed onto the payload transmissions. However, slower applications such as VoIP (Voice over Internet Protocol) or low bandwidth video (which are slow applications compared to the resources that are expected to be available within the framework of fourth generation mobile communications systems) frequently cause the transmission buffer be emptied, which in turn necessitates the transmission of a new access request when new data eventually is available.

An obvious solution to the problem would be either to make the application produce dummy packets when necessary to maintain a minimum rate of filling the transmission buffer, or to reserve some fixed amount of resources for the “slow” application. Said first obvious alternative would mean mandatorily wasting transmission resources, which is not recommendable. The second alternative would actually mean returning to circuit-switched connections, thus losing all advantages of packet-switched ones.

### SUMMARY OF THE INVENTION

Now there has been invented a method and necessary devices for effectively utilizing transmission resources in cases where a minimum rate of filling a transmission buffer is not guaranteed. The invention also presents a resource allocation method and devices for executing said method that would obviate the above-explained disadvantages of prior art.

The objectives of the invention are achieved by predicting the need of resources from other factors than solely the presence of data in a transmission buffer, and piggy-backing resource requests concerning such predicted needs onto other transmissions.

A method according to the invention is characterized by the features recited in the characterizing part of the independent claim directed to a method.

An information appliance according to the invention is characterized by the features recited in the characterizing part of the independent claim directed to an information appliance.

A network element according to the invention is characterized by the features recited in the characterizing part of the independent claim directed to a network element.

A communications module according to the invention is characterized by the features recited in the characterizing part of the independent claim directed to a communications module.

A computer program product according to the invention is characterized by the features recited in the characterizing part of the independent claim directed to a computer program product.

According to the invention, the entity that in a terminal arrangement decides to transmit requests for resources may consider also other criteria than just the contents of a transmission buffer when it evaluates the need of transmitting said requests. For example a source codec—such as a VoIP codec or video codec—may have a characteristic mean packet production rate, or it may be capable of operating in different modes, each mode being characterized by a typical packet production rate. A transmission of a packet from the terminal arrangement to the network may carry a piggy-backed piece of control information which informs a network element responsible for resource allocations about a predicted future need of resources. In addition to or in place of known features of hardware and/or software, the terminal arrangement may apply other kinds of prediction criteria, such as statistical analysis of previously realized packet rates or observations concerning the operation of the terminal arrangement. Even characteristics of the communications connection may be used as prediction criteria: for example a weakening trend of connection quality may lead to some predictable development concerning the need of resources, so the terminal arrangement may preparatorily inform the resource-allocating network element about the consequences that are to be expected, using piggy-backed control messages.

The exemplary embodiments of the invention presented in this patent application are not to be interpreted to pose limitations to the applicability of the appended claims. The verb “to comprise” is used in this patent application as an open limitation that does not exclude the existence of also unrecited features. The features recited in depending claims are mutually freely combinable unless otherwise explicitly stated.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF DRAWINGS

FIG. 1 illustrates a known method of piggy-backing access requests,

FIG. 2 illustrates a method according to an embodiment of the invention,

FIG. 3 illustrates functionalities of an information appliance according to an embodiment of the invention,

FIG. 4 illustrates hardware considerations of a terminal arrangement according to an embodiment of the invention,

FIG. 5 illustrates a method and a computer program product according to an embodiment of the invention as a state diagram,

FIG. 6 illustrates functionalities of a network element according to an embodiment of the invention,

FIG. 7 illustrates hardware considerations of a network element according to an embodiment of the invention, and

FIG. 8 illustrates a method and a computer program product according to an embodiment of the invention as a state diagram.

### DETAILED DESCRIPTION OF THE ADVANTAGEOUS EMBODIMENTS

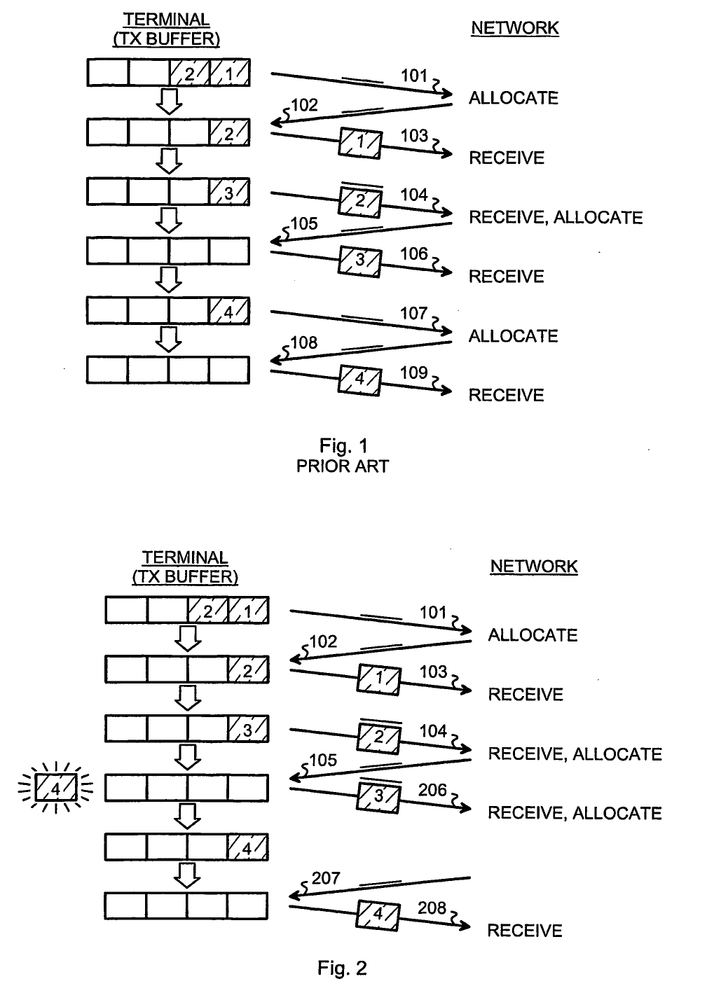

The procedure illustrated in FIG. 2 begins similarly as the corresponding procedure in FIG. 1: at stage 101 the terminal arrangement requests resources for transmitting two packets; at stage 102 the network grants the requested resources; at stage 103 the terminal arrangement transmits the first packet; at stage 104 the terminal arrangement transmits the second packet as well as a piggy-backed request for resources needed to transmit the third packet that appeared in the transmission buffer in the meantime; and at stage 105 the network grants the requested resources. However, even if at the moment of transmitting the third packet there are no further packets in the transmission buffer, the terminal arrangement is capable of predicting that a fourth packet will appear soon. Therefore at stage 206 the terminal arrangement transmits, piggy-backed on the transmission of the third packet, a request for resources needed to transmit the fourth packet. This request may have a slightly different form than an ordinary access request, in which the terminal arrangement would request resources for packets already appearing in the transmission buffer, because in the possible case of an immediate grant the fourth packet might not yet be completely ready for transmission. Preferably the piggy-backed access request transmitted at stage 206 includes some kind of an indication, when the requested resources will be needed at the earliest. It should be noted, though, that the invention does not exclude transmitting simply an ordinary piggy-backed access request at stage 206, especially if the criteria used for predicting the future appearance of additional packets are such that they will only notice future packets that will appear in the transmission buffer in a shorter time than the round-trip time of the medium access protocol.

In FIG. 2 we assume that the fourth packet appears in due time and is placed into the transmission buffer. When the appropriate grant message comes from the network at stage 207, the terminal arrangement may immediately transmit the fourth packet at stage 208. As an alternative, the grant message illustrated as appearing at stage 207 may come immediately after the network has processed the piggy-backed access request it received at stage 206 and inform the terminal arrangement about some future moment of time at which the grant is valid. In other words, according to said alternative, the unusually long wait would take place between the terminal arrangement receiving the grant and transmitting the packet the appearance of which it predicted, instead of taking place between the network received the access request for predicted traffic and transmitting the grant message.

Some messages, like the possibly modified access request piggy-backed on the third packet at stage 206 or a possible immediately arriving grant message informing the terminal arrangement about some future moment of time at which the grant is valid, should contain a reference to a future moment of time. If it is the modified, piggy-backed access request, it should inform the network about when the terminal expects to need the requested capacity. Correspondingly if it is the immediately arriving grant message, it should inform the terminal arrangement about when the grant is valid. At least three principles are applicable for such indications of time. The first principle is to indicate a future moment of time in relation to the transmission time of the message in question, like “T milliseconds from the time at which this message was transmitted”, where T is a real number. The second principle is to indicate a future moment of time in relation to a frame number or other system-specific timebase, but also in relation to the location of the message in question in said system-specific timebase, like “K frames later than the frame in which this message was transmitted”, where K is an integer. The third principle is to indicate an absolute moment in said system-specific timebase, like “in frame M”, where M is a frame number of some future frame. In principle it would be possible to even refer to an absolute moment of real time (like “at HH hours, MM minutes, and SS.sss seconds”), but this is easily by far the most cumbersome way.

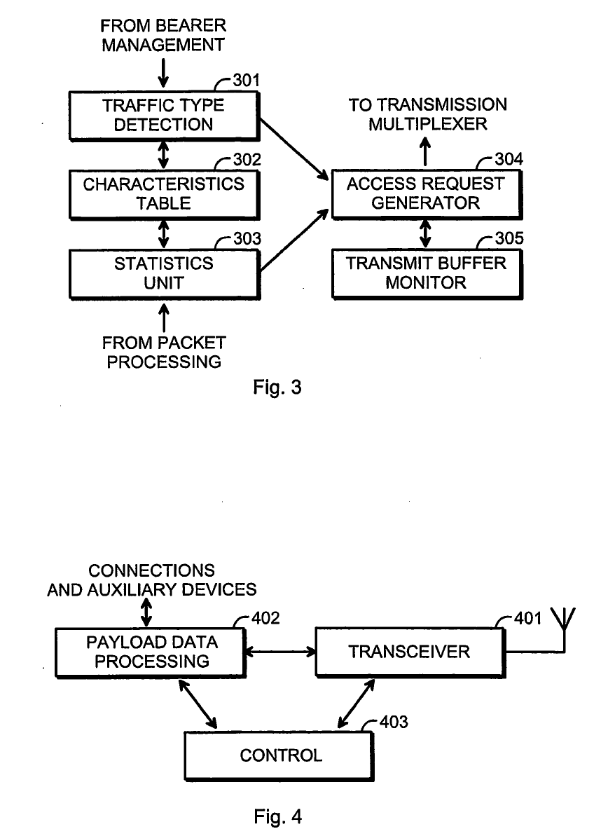

The invention does not limit the selection of a method used in a terminal arrangement for establishing knowledge about oncoming future packets that are not yet in the transmission buffer but will appear there soon enough to justify a preparatory piggy-backed access request. FIG. 3 illustrates some possible considerations. A terminal arrangement, parts of which are illustrated in FIG. 3, is adapted to establishing the appropriate knowledge with two alternative or mutually augmentative ways. A traffic type detection unit 301 is adapted to receive, for example from bearer management, information about traffic types: which bearer is used for VoIP, which for low bandwidth video, and so on. A characteristics table 302 is used in the terminal arrangement to store information about how the different traffic types behave in respect of packet production rate. The stored information may be updated for example by a statistics unit 303, which receives actual information from packet processing that has taken place in association with the different traffic types.

Based on the traffic type specific information the traffic type detection unit 301 is adapted to give predictions to an access request generator 304. If the predictions come in real time, a prediction might contain e.g. an announcement “the application using currently active bearer #4 is predicted to produce a next new packet in 40 milliseconds”. Alternatively the predictions may be more general in nature, like “the application using currently active bearer #4 typically produces packets at a rate of X packets per second”, where X is a real number, or “the application using currently active bearer #4 is likely to wait for Y milliseconds after every Z:th produced packet”, where Y is a real number and Z is an integer. In the case of these more general, non-real time announcements it remains on the responsibility of the access request generator 304 to decide upon the most appropriate time of generating a piggy-backed access request for predicted traffic, while in the case of real time announcements it may simply forward each such announcement to the network as one.

The statistics unit 303 may also give announcements of the kind explained above to the access request generator 304, even without knowing what type of traffic flows in each bearer, by only monitoring the actual flow of packets in each active bearer and by looking for regularities, like pauses that are longer than the MAC protocol round-trip time. The access requests generated by the access request generator 304 go to a transmission multiplexer, which combines them to payload packet transmissions whenever possible and practical. In order to also perform the normal task of requesting resources for transmitting packets that already appear in the transmission buffer the access request generator 304 is also coupled to a transmission buffer monitor 305. The functional means illustrated in FIG. 3 may be implemented in hardware and/or software according to convenience of design.

FIG. 4 illustrates some hardware considerations of a terminal arrangement. In general a “terminal arrangement” may refer to a single, compact terminal like a mobile phone, or it may refer to a combination of devices connected or coupled to each other, like a portable transceiver connected to a laptop computer and a camera. What appears to the network as a single terminal arrangement might even be a whole local network of interlinked devices, which share a common multiplexed network connection through a modem or gateway type device. For the purposes of the invention it is only important that there exists a transceiver 401, which sets up and maintains the bearers necessary for transferring information related to some payload data processing means 402. From the payload data processing means 402 there may be further connections to peripherals, auxiliary devices and other parts of what appears to the network as a terminal arrangement. A control block 403 includes, among others, the control functionalities responsible for medium access control, and therefore also the processing means adapted to consider the need for piggy-backed access requests for predicted traffic and to transmit them through the transceiver 401.

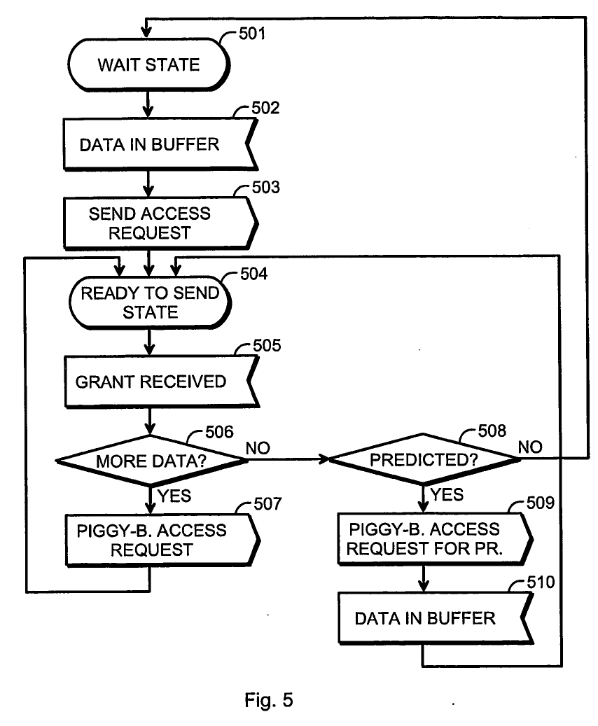

FIG. 5 illustrates a method according to an embodiment of the invention in the form of a state diagram. In the state machine representation of FIG. 5, a block with rounded ends represents a state, a block with a triangular indent at an end represents receiving information and a block with an arrow-shaped end represents transmitting information. A diamond-shaped block represents a decision with more than one possible outcome, and a rectangular block represents an action the results of which are internal to the state machine in question. The state machine is first at a wait state 501. When information is received about there being at least one packet of data in a transmission buffer according to step 502, an access request is transmitted according to step 503. After that the state machine is in a ready to send state 504, in which it waits for a permission to send. When a grant message is received at state 505, there follows a check at state 506 to find out whether the transmission buffer contains additional packets for which access requests should be transmitted. If yes, a piggy-backed access request is generated at step 507 and transmitted together with the packet for which a grant already existed, after which a return to the ready to send state 504 occurs.

A negative finding (buffer empty) at step 506 causes a transition to step 508 for checking, whether there exists information about predicted packet(s) for which a preparatory access request should be transmitted. Only a negative finding at step 508 causes the access request state machine to return to the wait state 501 (the packet for which a grant was received at step 505 is naturally transmitted first). A positive finding about predicted packets at step 508 triggers transmitting a piggy-backed access request for predicted traffic at step 509. When the predicted packet appears in the transmission buffer according to step 510, the state machine jumps to the ready to send state 504.

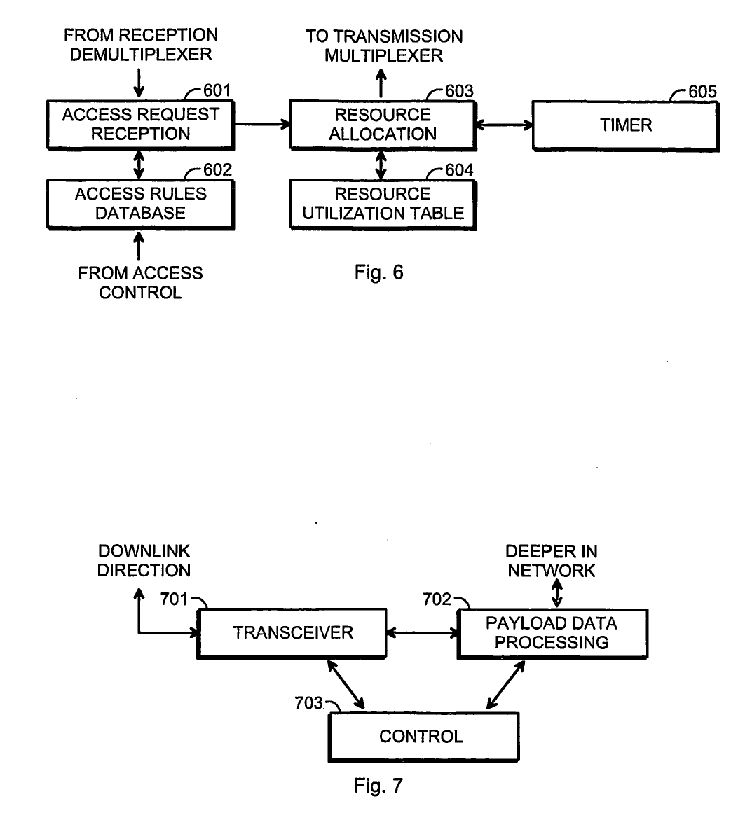

FIG. 6 illustrates certain functional means of a network element according to an embodiment of the invention. A reception demultiplexer separates access requests from the transmissions received from terminal arrangements and delivers to an access request reception unit 601. It checks the allowability of access requests with the help of an access rules database 602 which is maintained by arrangements responsible for network access control. Allowable access requests are forwarded to a resource allocation unit 603, which is adapted to grant communications resources and to maintain resource utilization tables 604 correspondingly. According to an embodiment of the invention the resource allocation unit 603 is adapted to separate between direct access requests and those made for predicted traffic, the latter type involving delays before granting the resources is expected. For implementing the necessary delays the resource allocation unit 603 is equipped with a timer 605. An alternative way of implementing the invention in a network element could involve storing rules for handling access requests made for predicted traffic into the access rules database 602, and making the access request reception unit 601 only forward those access requests to the resource allocation unit 601 after having waited for the appropriate delays. In that case the resource allocation unit 601 would not need to be capable of making any difference between access request types.

FIG. 7 is a simple schematic diagram of a network element, which comprises a transceiver 701 for communicating downwards in the network hierarchy, a payload data processing unit 702 for processing payload data and for communicating in the direction towards higher in the network as well as a control unit 703, which among others comprises the functional means illustrated in FIG. 6.

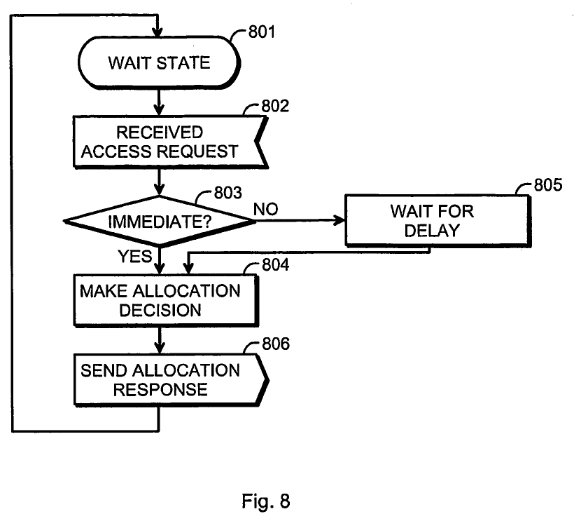

FIG. 8 is a state machine representation of the operation of a network element according to an embodiment of the invention. From a wait state 801 a reception of an access request at step 802 causes a transition to a decision at step 803, whether the access request is a direct one or concerns predicted traffic. In the first-mentioned case the allocation decision is made directly at step 804, while an access request for predicted traffic causes first a delay to be passed at step 805. After sending an allocation decision response (a grant or a refusal) at step 806 there occurs a return to the wait state 801.

The advantages of the invention involve making more efficient use of available radio resources, because fewer transmissions are needed and thus especially preamble overheads are diminished. The invention allows implementing a kind of a constant bit rate (CBR) service without any need for setup signaling or setting up some persistent state in network elements.

Generalisations and further developments of the invention are possible. For example, the invention as such does not define, what will happen if the network element is unable to grant the resources requested preparatorily for predicted traffic, or if a terminal arrangement made a false prediction and preparatorily requested resources for transmitting a packet that actually never showed up. Concerning the first-mentioned case it is possible to define that the network element simply will not transmit any response, which eventually leads to a situation where the predicted packet has appeared in the transmission buffer of the terminal arrangement already for longer than some predetermined time interval, without a grant being received from the network. After having waited for said delay the terminal may continue by transmitting a normal access request in the way it would do if the packet just appeared in the transmission buffer without having been predicted. In the case where the terminal arrangement has transmitted an access request for a predicted packet and such a predicted packet never appears, it is simplest to define that the terminal arrangement will just remain silent during the allocated transmission instant.

The terminal arrangement or part of a terminal arrangement that is used to implement the invention may vary greatly in complicatedness, capability and degree of completeness. For example, the functionalities according to the invention may take the form of a computer program product that, when loaded and made accessible to the control unit of a general purpose terminal device will control said terminal device to perform the appropriate actions. Alternatively the functionalities may be built into a processor or other functional module that is delivered to the industrial assembling stage of a terminal device or terminal arrangement. As one alternative there is a terminal arrangement according to the invention, which is complete and ready to be delivered to a user. As another alternative the tasks of predicting traffic and producing access requests for predicted traffic may be a task of a communications module, which will not perform the actual piggy-backed transmission by itself but is only adapted to deliver the access requests for predicted traffic to a transmission multiplexer for producing the piggy-backed transmissions. It is common to all hardware implementations of the terminal arrangement according to the invention that they can be designated as information appliances.

1. A method for handling requests for resources in a packet-switched communications system comprising:
a terminal arrangement sending an access request to a network element in order to request permission to use communications resources for transmitting a data packet found in a transmission buffer of the terminal arrangement,
establishing knowledge about a predicted data packet which is to appear in the transmission buffer of the terminal arrangement, before said predicted data packet appears in the transmission buffer of the terminal arrangement and
transmitting from the terminal arrangement to the network element an access request for predicted traffic, requesting permission to use communications resources for transmitting said predicted data packet once it appears;
wherein transmitting said access request for predicted traffic involves combining said access request for predicted traffic with another transmission.

2. A method according to claim 1, wherein the establishing knowledge about a predicted data packet involves recognizing a type of traffic that is conveyed through a bearer and using known features of said type of traffic to produce knowledge about a predicted data packet.

3. A method according to claim 1, wherein the establishing knowledge about a predicted data packet involves making a statistical analysis of the actual appearance of data packets in a communications connection and deriving knowledge about a predicted data packet as an extrapolation into future of said statistical analysis.

4. A method according to claim 1, wherein the transmitting an access request for predicted traffic involves announcing a future moment of time at which resources are expected to be needed for said predicted traffic.

5. A method according to claim 4, wherein said announcing is accomplished by giving at least one of the following: a future moment of time in relation to the transmission time of said access request for predicted traffic, a future moment of time in relation to a system-specific timebase and also in relation to the location of said access request for predicted traffic in said system-specific timebase, a future absolute moment in a system-specific timebase.

6. An information appliance for handling requests for resources in a packet-switched communications system, comprising:
an access request generator adapted to generate access requests to network elements in order to request permission to use communications resources for transmitting data packets;
a data packet predictor adapted to establish knowledge about a predicted data packet which is to appear in a transmission buffer before said predicted data packet appears in said transmission buffer,
said data packet predictor is adapted to inform the access request generator about said predicted data packet,
the access request generator is adapted to compose an access request for predicted traffic, requesting permission to use communications resources for transmitting said predicted data packet once it appears, and
the information appliance is adapted to transmit said access request for predicted traffic in combination with another transmission.

7. An information appliance according to claim 6, wherein said data packet predictor comprises a traffic type detection unit adapted to detect a type of traffic that is conveyed through a bearer and to use known features of said type of traffic to produce knowledge about a predicted data packet.

8. An information appliance according to claim 6, wherein said data packet predictor comprises a statistical analysis unit adapted to make a statistical analysis of the actual appearance of data packets in a communications connection and to derive knowledge about a predicted data packet as an extrapolation into future of said statistical analysis.

9. An information appliance according to claim 6, wherein it is adapted to wait, after having transmitted an access request for predicted traffic, for a time period longer than a round-trip time of a medium access control protocol of the packet-switched communications system before receiving a response to said access request for predicted traffic.

10. An information appliance according to claim 6, wherein it is adapted to announce in said access request for predicted traffic when the communications resources requested in said access request for predicted traffic will be needed.

11. An information appliance according to claim 10, wherein it is adapted to announce, in said access request for predicted traffic, at least one of the following: a future moment of time in relation to the transmission time of said access request for predicted traffic, a future moment of time in relation to a system-specific timebase and also in relation to the location of said access request for predicted traffic in said system-specific timebase, a future absolute moment in a system-specific timebase.

12. A communications module for handling requests for resources in a packet-switched communications system, comprising:
an access request generator adapted to generate access requests to network elements in order to request permission to use communications resources for transmitting data packets;
a data packet predictor adapted to establish knowledge about a predicted data packet which is to appear in a transmission buffer before said predicted data packet appears in said transmission buffer,
said data packet predictor is adapted to inform the access request generator about said predicted data packet,
the access request generator is adapted to compose an access request for predicted traffic, requesting permission to use communications resources for transmitting said predicted data packet once it appears, and
the access request generator is adapted to deliver said access request for predicted traffic to a transmission multiplexer for combining said access request with another transmission.

13. A network element for handling requests for resources in a packet-switched communications system, comprising:
an access request reception unit adapted to receive access requests from terminal arrangements, said access requests requesting permission to use communications resources for transmitting data packets; wherein
the network element is adapted to separate access requests from combinations with other transmissions,
the network element is adapted to recognize access requests for predicted traffic, requesting permission to use communications resources for transmitting predicted data packets later than one round-trip time of a medium access control protocol of the packet-switched communications system after the transmission moment of an access request for predicted traffic and
the network element is adapted to grant delayed permission to use communications resources as a response to an access request for predicted traffic.

14. A network element according to claim 13, wherein the access request reception unit is adapted to recognize access requests for predicted traffic and to delay forwarding recognized access requests for predicted traffic to a resource allocation unit.

15. A network element according to claim 13, wherein the access request reception unit is adapted to forward all access requests for predicted traffic to a resource allocation unit, and said resource allocation unit is adapted to delay responding to recognized access requests for predicted traffic.

16. A network element according to claim 13, wherein
the access request reception unit is adapted to forward all access requests for predicted traffic to a resource allocation unit,
said resource allocation unit is adapted to respond without delay to recognized access requests for predicted traffic, and
said resource allocation unit is adapted to announce, in a response to a recognized access request for predicted traffic, a future moment of time at which a resource allocation made in response to said recognized access request for predicted traffic will be valid.

17. A network element according to claim 16, wherein said resource allocation unit is adapted to announce at least one of the following: a future moment of time in relation to the transmission time of a response to said recognized access request for predicted traffic, a future moment of time in relation to a system-specific timebase and also in relation to the location of a response to said recognized access request for predicted traffic in said system-specific timebase, a future absolute moment in a system-specific timebase.

18. A computer program product for controlling an information appliance in a process of handling requests for resources in a packet-switched communications system, the computer program product comprising program code stored in a memory for execution by a processor
for setting up an access request generator adapted to generate access requests to network elements in order to request permission to use communications resources for transmitting data packets;
for making a data packet predictor establish knowledge about a predicted data packet which is to appear in a transmission buffer before said predicted data packet appears in said transmission buffer,
for making said data packet predictor inform the access request generator about said predicted data packet,
for making the access request generator compose an access request for predicted traffic, requesting permission to use communications resources for transmitting said predicted data packet once it appears, and
for making the information appliance transmit said access request for predicted traffic in combination with another transmission.

19. An information appliance for handling requests for resources in a packet-switched communications system, comprising:
means for generating access requests to network elements in order to request permission to use communications resources for transmitting data packets;
means for establishing knowledge about a predicted data packet which is to appear in a transmission buffer before said predicted data packet appears in said transmission buffer,
said means for establishing knowledge for informing the means for generating access requests about said predicted data packet,
said means for generation access requests for composing an access request for predicted traffic, requesting permission to use communications resources for transmitting said predicted data packet once it appears, and
said means for establishing knowledge for transmitting said access request for predicted traffic in combination with another transmission.
